(19) United States
(12) Patent Application Publication
(10) Pub. No.: US 2021/0142672 A1
(43) Pub. Date: May 13, 2021

(54) METHOD, MOBILE DEVICE AND SYSTEM FOR VEHICLE-TO-EVERYTHING (V2X) COMMUNICATION

(71) Applicant: Wistron NeWeb Corp., Hsinchu (TW)

(72) Inventor: Chi-Lin TSAI, Hsinchu (TW)

(21) Appl. No.: 17/003,109

(22) Filed: Aug. 26, 2020

(30) Foreign Application Priority Data
Nov. 11, 2019 (TW) 108140791

(51) Int. Cl. G08G 1/16; H04W 4/46; H04W 4/44; H04W 4/48

(52) U.S. Cl. CPC G08G 1/162; H04W 4/48; H04W 4/44; H04W 4/46

(57) ABSTRACT

A method for vehicle-to-everything (V2X) communication is provided. The method is used in a mobile device placed in a first vehicle and includes: receiving an event signal corresponding to an event; determining whether to perform an action according to the event signal; wherein the action belongs to one of the following: generating a warning signal to warn a user of the first vehicle that the event has occurred; and transmitting a notification signal to a cloud device to notify neighboring second vehicles associated with the first vehicle of the event through the cloud device.

### CROSS REFERENCE TO RELATED APPLICATIONS

100011 This application claims priority from Taiwan Patent Application No. 108140791, filed on Nov. 11, 2019, the disclosure of which is incorporated herein by reference in its entirety.

### BACKGROUND

### Technical Field

The present disclosure generally relates to a method, mobile device and system for Vehicle-to-everything (V2X) communication. More specifically, aspects of the present disclosure relate to a method, mobile device and system for V2X communication that replace traditional V2X vehicle communication devices.

### Description of the Related Art

Vehicle-to-everything (V2X) refers to providing vehicle information via sensors, onboard terminals, and electronic tags mounted on the vehicle, implementing interconnection and intercommunication of Vehicle to Vehicle (V2V), Vehicle to Network (V2N) and Vehicle to Infrastructure (V2I) using various communication technologies, extracting and sharing information on an information network platform for effective use, and effectively controlling the vehicles, and providing comprehensive services. FIG. 1 is a schematic diagram of V2V, V2N and V2I in the related art.

The V2X system currently developed in the United States and Europe mainly detects roads and driving conditions of surrounding vehicle by installing a V2X device used for vehicle communication system to improve driving safety assistance. However, since V2X equipment is expensive to manufacture and most V2X equipment must be installed when the vehicle is shipped from the factory, drivers must do vehicle positioning and installation through vehicle equipment dealers for drivers who do not install V2X equipment at first and it may cause great inconvenience.

Therefore, there is a need for a method, mobile device, and system for V2X communication to improve the problems.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, the main purpose of the present disclosure is to provide a method, mobile device and system for V2X communication that replace traditional V2X vehicle communication devices to overcome the above disadvantages.

In an exemplary embodiment, a method for vehicle-to-everything (V2X) communication, used in a mobile device placed in a first vehicle, comprising: receiving an event signal corresponding to an event; determining whether to perform an action according to the event signal; wherein the action belongs to one of the following: generating a warning signal to warn a user of the first vehicle that the event has occurred; and transmitting a notification signal to a cloud device to notify neighboring second vehicles associated with the first vehicle of the event through the cloud device.

In an exemplary embodiment, a mobile device for vehicle-to-everything (V2X) communication, comprising: one or more processors; and one or more computer storage media for storing one or more computer-readable instructions, wherein the processor is configured to drive the computer storage media to execute the following tasks: receiving an event signal corresponding to an event; determining whether to perform an action according to the event signal; wherein the action belongs to one of the following: generating a warning signal to warn a user of the first vehicle that the event has occurred; and transmitting a notification signal to a cloud device to notify neighboring second vehicles associated with the first vehicle of the event through the cloud device.

In an exemplary embodiment, a system for vehicle-to-everything (V2X) communication, comprising: a cloud device, receiving an event signal corresponding to an event; and a mobile device, located in a first vehicle in an area; wherein the cloud device broadcasts the event signal to all vehicles in the area, and the area has a range centered on the event.

### BRIEF DESCRIPTION OF DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram of V2V, V2N and V2I in the related art.

FIG. 2 is a schematic diagram illustrating a system for V2X communication according to an embodiment of the disclosure.

FIG. 3 shows a message according to an embodiment of the disclosure.

FIG. 4 is a flowchart illustrating a method for vehicle-to-everything (V2X) communication according to an embodiment of the present disclosure.

FIG. 5 is a schematic diagram illustrating the distribution of the first vehicle and the second vehicle according to an embodiment of the disclosure.

FIG. 6 is a flowchart illustrating a method for vehicle-to-everything (V2X) communication according to an embodiment of the present disclosure.

FIG. 7 is a flowchart illustrating a case where the first vehicle attempts to turn left under a traffic light-free intersection according to an embodiment of the disclosure.

FIG. 8 is a flowchart illustrating a situation in which a failure occurs in the first vehicle according to an embodiment of the disclosure.

FIG. 9 is a flowchart illustrating a situation in which a failure occurs in the first vehicle according to an embodiment of the disclosure.

FIG. 10 is a flowchart illustrating a situation of road construction according to an embodiment of the disclosure.

FIG. 11 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The present disclosure provides a method, mobile device and system for V2X communication, which can be applied to a vehicle security system, based on vehicle-to-everything (V2X) communication, and may achieve the purpose of informing a specific vehicle through the information exchange between an on board device (OBD) or an electronic control unit (ECU), a mobile node of the driver and a cloud device. In addition to warning specific vehicles and avoiding vehicle interference caused by unwanted information received from other vehicles, the method, mobile device and system for V2X communication provided in the present disclosure can also assist autonomous vehicles in real-time determination to further assist driving safety.

FIG. 2 is a schematic diagram illustrating a system 200 for V2X communication according to an embodiment of the disclosure. Specifically, the system 200 is a communication system based on V2X communication. As shown in FIG. 2, the system 200 may comprise vehicles 210, mobile devices 220 placed in the vehicles 210 and a cloud device 230.

In some embodiments, each of the vehicles 210 may be a vehicle equipped with an on-board device (OBD), an electronic control unit (ECU), or a driving computer with communication capabilities while traveling on the road.

The mobile device 220 may support various wireless access technologies, and the mobile device 220 may be an electronic device such as a mobile phone, a notebook, a smartphone, a tablet computer and so on. The mobile device 220 may at least comprise a communication device and a processor (not shown in FIG. 2) for performing wireless transmission with the vehicles 210 and the cloud device 230. The mobile device 220 may perform wired communication and/or wireless communication of voice and/or data services with the network 240. The wireless communications between the mobile device 220 and the networks 240 may be in compliance with various wireless technologies, such as the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA 2000) technology, Time Division-Synchronous Code Division Multiple Access (TD-SCDMA) technology, Worldwide Interoperability for Microwave Access (WiMAX) technology, Long Term Evolution (LTE) technology, Long Term Evolution Advanced (LTE-A) technology, and others.

The driver of the vehicle 210 can also download and install an exclusive service application developed by cloud device 230 through the mobile device 220 (for ease of understanding, hereinafter referred to as “service APP”), so that the driver can transmit the relevant information of the vehicle 210 to the cloud device 230 through the service APP, or receives and records the driving information of the surrounding vehicles updated by the cloud server through the service APP. In addition, the electronic control unit (ECU) or other device of the vehicle 210 may update the related information of the vehicle (for example, information about engine failure, insufficient tire pressure, etc.) to the on board device (OBD) or the driving computer through the controller area network (CAN or CAN bus). The OBD or the driving computer transmits the related information of the vehicle to the service APP of the mobile device 220 via Bluetooth or a Universal Serial Bus (USB). A wearable device worn on the driver can also transmit the physical and fatigue conditions to the service APP of the mobile device 220. The service APP may determine whether to transmit the physical and fatigue conditions to the cloud device 230 and users of other vehicles.

The cloud device 230 may receive vehicle information transmitted by the service APP of the mobile device 220, and broadcast each vehicle information to every vehicle for exchange of information. For example, the cloud device 230 may record the vehicle information (for example, the triggering event, the time, the position of the vehicle, the speed of the vehicle, the driving direction, etc.) transmitted by each vehicle through the service APP of the mobile device 220. The cloud device 230 broadcasts other vehicle information according to the position of the vehicle. The current driver may receive the related information of surrounding vehicles and other drivers or users broadcasted and updated from the cloud device 230 in real time through the service APP to determine whether to remind the drivers or users via the relevant user interface (such as, a light emitting diode (LED), a display, a microphone, a buzzer or a Bluetooth streaming) of the mobile device 220.

In addition, the cloud device 230 may also provide traffic information (such as accident notification, road construction, traffic closure information and so on) in various places and a security authentication program for the service APP of the mobile device 220. The cloud device 230 may request the driver for registration and verify the driver's identity and the packets transmitted by the mobile device 220 to perform security checks and control on information exchange and meet the requirements for data security and correctness. The mobile device 220 may be responsible for certificate management (for example, certificate renewal and cancellation), data encryption and decryption, security verification and signature of packet transmission.

In an embodiment, the packets or messages transmitted and received between the mobile device 220 and the cloud device 230 may have a special format. FIG. 3 shows a message 300 according to an embodiment of the disclosure. The message 300 comprises a header field 310, a payload field 320, and a signature field 330. The header field 310 can be divided into multiple fields, as shown in Table 1.

TABLE 1

| | | Length | |
|---|---|---|---|
| Field | Content | (Byte) | Remark |
| MSG_SEQ | Message | 8 | Message sequence number of |
| | Sequence | | the individual message |
| | Number | | maintained by the message |
| | | | transmitter |
| MSG_TYPE | Message Type | 1 | 0x01: Command |
| | | | 0x02: Response |
| | | | 0x03: Warning |
| | | | 0x04: Acknowledgement |
| | | | (ACK) |
| MSG_TX | Message | 8 | Transmitter which transmits |
| | Transmitter | | commands and |
| | | | acknowledgements is the |
| | | | cloud device |
| | | | Transmitter which transmits |
| | | | responses and warnings is |
| | | | the mobile device |
| MSG_RX | Message | 8 | Receiver which receives |
| | Receiver | | commands and |
| | | | acknowledgements is the |
| | | | mobile device |
| | | | Receiver which receives |
| | | | responses and warnings is |
| | | | the cloud device |
| MSG_CODE | Message | 1 | Command/Response ID and |
| | Code | | Warning Code |
| LEN | Message | 2 | Length of payload: 0~1024 |
| | Length | | |

The payload field 320 can also be divided into multiple fields, as shown in Table 2.

TABLE 2

| Field | Content | Length (Byte) | Remark |
|---|---|---|---|
| DAT_TYPE | Specific data type | 2 | |
| DAT_LEN | Specific data length | 2 | 0~1020 |
| DAT | Specific data content | 0~1020 | |

A detailed description of the signature field 330 is shown in Table 3.

TABLE 3

| Field | Content | Length (Byte) | Remark |
|---|---|---|---|
| SIG | Digital signature | 64 | Hash header and |
| | | | payload via Secure |
| | | | Hash Algorithm |
| | | | (SHA) 256 |
| | | | Digital signature of |
| | | | the hash value |
| | | | obtained via Elliptic |
| | | | Curve Digital |
| | | | Signature Algorithm |
| | | | (ECDSA) |

The MSG CODE in the header field 310 can be defined as the following types, as shown in Table 4.

TABLE 4

| MSG CODE | Definition |
|---|---|
| 0x01 | Certificate renewal |
| 0x02 | Certificate cancellation |
| 0x03 | Traffic condition |
| 0x04 | Speed limit |
| 0x05 | Traffic light |
| 0x06 | Neighboring vehicle status |
| 0x07 | Neighboring vehicle positioning |
| 0x08 | Read configuration |
| 0x09 | Setting configuration |

The warning code of the MSG CODE in the header field 310 can be defined as the following types, as shown in Table 5.

TABLE 5

| MSG_CODE | Definition |
|---|---|
| 0x80 | Vehicle positioning |
| 0x81 | Keep running |
| 0x82 | Pull up the handbrake |
| 0x83 | Engine start |
| 0x84 | Engine off |
| 0x85 | Vehicle breakdown |
| 0x86 | Turn left |
| 0x87 | Turn right |
| 0x88 | Emergency brake |
| 0x89 | State of driver |
| 0x8A | Configuration |

It should be noted that the types and definitions of the fields are not intended to limit this disclosure, and those skilled in the art can make appropriate replacements or adjustments according to this embodiment.

In addition, the mobile device 220 may also comprise a map database for storing the current position of the vehicle, routes, and road information to provide the service APP to determine whether to issue a warning. In an embodiment, the processor of the mobile device 220 may also accelerate data calculation and artificial intelligence interpretation according to the current application requirements, usage scenarios, and user habits or settings to provide the most accurate suggestions and reminders for the driver, and reduce a large amount of vehicle information uploaded to the cloud device 230.

It should be understood that the mobile devices 220 and the cloud device 230 shown in FIG. 2 is an example of one suitable system 200 for V2X communication architecture. Each of the components shown in FIG. 2 can be implemented via any type of electronic device, such as the electronic device 1100 described with reference to FIG. 11, for example.

FIG. 4 is a flowchart illustrating a method 400 for vehicle-to-everything (V2X) communication according to an embodiment of the present disclosure. The method can be implemented in the mobile devices 220 of the system 200 for V2X communication as shown in FIG. 2, and the mobile device 220 is placed in a first vehicle.

In step S405, the mobile device receives an event signal corresponding to an event, wherein the event signal corresponding to the event is transmitted by the first vehicle or the cloud device. Then, in step S410, the mobile device determines whether to perform an action according to the event signal, wherein the action belongs to one of the following: generating a warning signal to warn a user of the first vehicle that the event has occurred; and transmitting a notification signal to a cloud device to notify neighboring second vehicles associated with the first vehicle of the event through the cloud device.

In an embodiment, before the mobile device receives an event signal corresponding to an event, the mobile device may continuously receive road information and second vehicle information transmitted by the cloud device at a fixed period (e.g., 5 seconds). Specifically, the road information comprises weather, road conditions, traffic light conditions, driving directions about lane control, information of whether the lane is open, average speed, congestion status, accidents, construction status, and other information in an area centered on the first vehicle. The second vehicle information provides position distribution information of the neighboring second vehicles associated with the first vehicle within the area.

In another embodiment, the mobile device may continuously obtain first vehicle information through at least one sensor (for example, a global positioning system (GPS) sensor), wherein the first vehicle information provides position information associated with the first vehicle. The mobile device may then transmit the first vehicle information to the cloud device.

Specifically, FIG. 5 is a schematic diagram illustrating the distribution of the first vehicle and the second vehicle according to an embodiment of the disclosure. As shown in FIG. 5, since the cloud device may continuously receive the first vehicle information transmitted by the mobile device placed on the first vehicle 510, the cloud device may transmit the road information and the second vehicle information in an area 500 centered on the first vehicle 510 according to the position information of the first vehicle 510. In the embodiment, the second vehicle information is the position distribution information of the neighboring second vehicles 520 associated with the first vehicle 510 in the area 500.

FIG. 6 is a flowchart illustrating a method 600 for vehicle-to-everything (V2X) communication according to an embodiment of the present disclosure. The method can be implemented in the cloud device 230 of the system 200 for V2X communication as shown in FIG. 2.

In step S605, the cloud device receives an event signal corresponding to an event. Then, in step S610, the cloud device broadcasts the event signal to all vehicles in an area, wherein the area has a range centered on the event.

In an embodiment, the event signal corresponding to the event may be transmitted by a mobile device placed in a first vehicle in the area. The cloud device may receive first vehicle information transmitted from the mobile device in the first vehicle, wherein the first vehicle information provides position information associated with the first vehicle among the vehicles. The cloud device may then broadcast the event signal to all vehicles except the first vehicle in the area centered on the first vehicle.

The flow of how the mobile device and the cloud device work in some cases will be described in detail below.

FIG. 7 is a flowchart illustrating a case where the first vehicle attempts to turn left under a traffic light-free intersection according to an embodiment of the disclosure. Before the start of the process, a mobile device placed in the first vehicle can continuously receive the road information and second vehicle information transmitted by the cloud device, wherein the second vehicle information provides position distribution information of the neighboring second vehicles associated with the first vehicle.

In step S705, the mobile device receives an event signal corresponding to an event, wherein the event is the first vehicle turning left. The electronic control unit (ECU) or on-board device (OBD) of the first vehicle may detect a left turn signal triggered by driver and transmit an event signal corresponding to the left turn of the first vehicle to the mobile device. In step S710, the mobile device determines whether there is a second vehicle approaching the route of the left turn of the first vehicle according to the event signal corresponding to the first vehicle turning left and the second vehicle information transmitted by the cloud device. When the mobile device determines that there is a second vehicle approaching the left-turning route of the first vehicle (“Yes” in step S710), in step S715, the mobile device generates a warning signal to warn a user of the first vehicle that a second vehicle will approach the route. When the mobile device determines that there is no second vehicle approaching the left-turning route of the first vehicle (“No” in step S710), the process ends.

Obviously, in the case where the first vehicle attempts to turn left at the intersection without a signal light, the mobile device can infer that the positions, speed, and routes of the neighboring second vehicles through the position distribution information of the neighboring second vehicles associated with the first vehicle collected by the cloud device to provide additional assistance information beyond the sight of the driver. The additional assistance information can be used as a basis for determining when the driver should turn left to avoid vehicle collisions.

FIG. 8 is a flowchart illustrating a situation in which a failure occurs in the first vehicle according to an embodiment of the disclosure. Before the start of the process, a mobile device placed in the first vehicle can continuously receive the road information and second vehicle information transmitted by the cloud device, wherein the second vehicle information provides position distribution information of the neighboring second vehicles associated with the first vehicle. In addition, the mobile device may also obtain first vehicle information by at least one sensor, wherein the first vehicle information provides position information associated with the first vehicle.

In step S805, the mobile device receives an event signal corresponding to an event, wherein the event is a failure of the first vehicle. An electronic control unit (ECU) or an on-board device (OBD) of the first vehicle may detect a fault light signal turned on by the driver, and transmit an event signal corresponding to the failure of the first vehicle to the mobile device. In step S810, the mobile device determines whether the first vehicle is moving or located on a road according to the event signal corresponding to the failure of the first vehicle and the first vehicle information obtained by the mobile device through at least one sensor. When the mobile device determines that the first vehicle is moving or is located on a road (“Yes” in step S810), in step S815, the mobile device transmits a notification signal to the cloud device, so that the event of the failure of the first vehicle is broadcast to the neighboring second vehicles associated with the first vehicle through the cloud device, wherein the notification signal may comprise a time stamp. When the mobile device determines that the first vehicle is not moving or is not located on a road (for example, a parking lot) (“No” in step S810), the process ends.

Next, in step S820, the mobile device determines whether the event of the failure of the first vehicle has been eliminated. The ECU or the OBD of the first vehicle may detect whether the fault light signal is turned off by the driver or determine whether the time difference between the current time and the time stamp has exceeded a preset value. Specifically, when the first vehicle detects that the driver has turned off the fault light signal or determines that the time difference between the current time and the time stamp has exceeded the preset value, the mobile device may determine that the event of the failure of the first vehicle has been eliminated. When the mobile device determines that the event of the failure of the first vehicle has been eliminated (“Yes” in step S820), in step S825, the mobile device transmits a signal that the event has been eliminated to the cloud device, so that the event in which the failure of the first vehicle has been eliminated is broadcast to the neighboring second vehicles associated with the first vehicle through the cloud device. When the mobile device determines that the failure of the first vehicle has not been eliminated (“No” in step S820), in step S830, the mobile device continuously transmits a notification signal to the cloud device, so that the event of failure of the first vehicle is broadcast to the neighboring second vehicles associated with the first vehicle through the cloud device. The process returns to step S820, and the mobile device determines whether the event of the failure of the first vehicle has been eliminated.

As shown in FIG. 8, in case of a failure of the first vehicle, the mobile device may broadcast a notification signal of the failure of the first vehicle to the neighboring second vehicles associated with the first vehicle through the cloud device, so that the drivers of the neighboring second vehicles may pay attention to driving safety when the second vehicle passes the section.

FIG. 9 is a flowchart illustrating a situation in which a failure occurs in the first vehicle according to an embodiment of the disclosure. Before the start of the process, a mobile device placed in the second vehicle may continuously receive the road information and first vehicle information transmitted by the cloud device, wherein the first vehicle information provides position information associated with the first vehicle. In addition, the mobile device may also obtain second vehicle information by at least one sensor, wherein the second vehicle information provides position information associated with the second vehicle.

In step S905, the mobile device receives an event signal corresponding to an event broadcasted by the cloud device, wherein the event is a failure of the first vehicle. In step S910, the mobile device may determine whether the second vehicle approaches the position in which the event of the failure of first vehicle occurs according to the event signal corresponding to the failure of the first vehicle and the second vehicle information obtained by the mobile device through at least one sensor. When the mobile device determines that the second vehicle approaches the position in which the event of the failure of first vehicle occurs (“Yes” in step S910), in step S915, the mobile device generates a warning signal to warn the user of the second vehicle that the second vehicle will approach the position of the event. When the mobile device determines that the second vehicle does not approach the position in which the event of the failure of first vehicle occurs (“No” in step S910), the process ends.

In another embodiment, before step S910 is performed, the mobile device may further confirm whether an event signal corresponding to an event broadcast by the cloud device is valid. Each packet transmitted from the cloud device to the mobile device may comprise a signature. When the mobile device confirms that the signature is valid, the subsequent steps are performed.

As shown in FIG. 9, in case of a failure of the first vehicle, the mobile device placed in the second vehicle may receive the notification signal of the failure of the first vehicle through the cloud device to remind the driver to pay attention to road safety when passing the position of the failure.

FIG. 10 is a flowchart illustrating a situation of road construction according to an embodiment of the disclosure. Before the start of the process, a mobile device placed in the first vehicle can continuously receive the road information and second vehicle information transmitted by the cloud device, wherein the second vehicle information provides position distribution information of the neighboring second vehicles associated with the first vehicle. In addition, the mobile device may also obtain first vehicle information by at least one sensor, wherein the first vehicle information provides position information associated with the first vehicle.

In step S1005, the mobile device receives an event signal corresponding to an event broadcasted by the cloud device, wherein the event is a road construction. In step S1010, the mobile device may determine whether the first vehicle approaches the position in which the event of the road construction occurs according to the event signal corresponding to the road construction and the first vehicle information obtained by the mobile device through at least one sensor. When the mobile device determines that the first vehicle approaches the position in which the event of the road construction occurs (“Yes” in step S1010), in step S1015, the mobile device generates a warning signal to warn the user of the first vehicle that the first vehicle will approach the position of the event. When the mobile device determines that the first vehicle does not approach the position in which the event of the road construction occurs (“No” in step S1010), the process ends.

In another embodiment, before step S1010 is performed, the mobile device may further confirm whether an event signal corresponding to an event broadcast by the cloud device is valid. Each packet transmitted from the cloud device to the mobile device may comprise a signature. When the mobile device confirms that the signature is valid, the subsequent steps are performed.

As shown in FIG. 10, in case of road construction, the mobile device placed in the first vehicle may receive the notification signal of the road construction through the cloud device to remind the driver to pay attention to road safety when passing the road construction.

As mentioned above, through the method, mobile device and system for V2X communication, it is only necessary to use a mobile device to download an APP and install the mobile device on a vehicle, and the purpose of connecting to a cloud device through a mobile network without setting up a V2X device and exchanging data with surrounding vehicles can be achieved.

Having described embodiments of the present disclosure, an exemplary operating environment in which embodiments of the present disclosure may be implemented is described below. Referring to FIG. 11, an exemplary operating environment for implementing embodiments of the present disclosure is shown and generally known as an electronic device 1100. The electronic device 1100 is merely an example of a suitable computing environment and is not intended to limit the scope of use or functionality of the disclosure. Neither should the electronic device 1100 be interpreted as having any dependency or requirement relating to any one or combination of components illustrated.

The disclosure may be realized by means of the computer code or machine-useable instructions, including computer-executable instructions such as program modules, being executed by a computer or other machine, such as a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 11, the electronic device 1100 may include a bus 1110 that is directly or indirectly coupled to the following devices: one or more memories 1112, one or more processors 1114, one or more display components 1116, one or more input/output (I/O) ports 1118, one or more input/output components 1120, and an illustrative power supply 1122. The bus 1110 may represent one or more kinds of busses (such as an address bus, data bus, or any combination thereof). Although the various blocks of FIG. 11 are shown with lines for the sake of clarity, and in reality, the boundaries of the various components are not specific. For example, the display component such as a display device may be considered an I/O component and the processor may include a memory.

The electronic device 1100 typically includes a variety of computer-readable media. The computer-readable media can be any available media that can be accessed by electronic device 1100 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 1100. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 1112 may include computer-storage media in the form of volatile and/or nonvolatile memory. The memory may be removable, non-removable, or a combination thereof. Exemplary hardware devices include solid-state memory, hard drives, optical-disc drives, etc. The electronic device 1100 includes one or more processors that read data from various entities such as the memory 1112 or the I/O components 1120. The display component(s) 1116 present data indications to a user or to another device. Exemplary presentation components include a display device, speaker, printing component, vibrating component, etc.

The I/O ports 1118 allow the electronic device 1100 to be logically coupled to other devices including the I/O components 1120, some of which may be embedded. Illustrative components include a microphone, joystick, game pad, satellite dish, scanner, printer, wireless device, etc. The I/O components 1120 may provide a natural user interface (NUI) that processes gestures, voice, or other physiological inputs generated by a user. For example, inputs may be transmitted to an appropriate network element for further processing. A NUI may be implemented to realize speech recognition, touch and stylus recognition, facial recognition, biometric recognition, gesture recognition both on screen and adjacent to the screen, air gestures, head and eye tracking, touch recognition associated with displays on the electronic device 1100, or any combination thereof. The electronic device 1100 may be equipped with depth cameras, such as stereoscopic camera systems, infrared camera systems, RGB camera systems, or any combination thereof, to realize gesture detection and recognition. Furthermore, the electronic device 1100 may be equipped with accelerometers or gyroscopes that enable detection of motion. The output of the accelerometers or gyroscopes may be provided to the display of the electronic device 1100 to carry out immersive augmented reality or virtual reality.

Furthermore, the processor 1114 in the electronic device 1100 can execute the program code in the memory 1112 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for vehicle-to-everything (V2X) communication, used in a mobile device placed in a first vehicle, comprising:
receiving an event signal corresponding to an event;
determining whether to perform an action according to the event signal;
wherein the action belongs to one of the following:
generating a warning signal to warn a user of the first vehicle that the event has occurred; and
transmitting a notification signal to a cloud device to notify neighboring second vehicles associated with the first vehicle of the event through the cloud device.

2. The method for vehicle-to-everything communication as claimed in claim 1, wherein the event signal corresponding to the event is transmitted by the first vehicle or the cloud device.

3. The method for vehicle-to-everything communication as claimed in claim 1, further comprising:
receiving road information and second vehicle information transmitted by the cloud device, wherein the second vehicle information provides position distribution information of the neighboring second vehicles associated with the first vehicle.

4. The method for vehicle-to-everything communication as claimed in claim 1, further comprising:
obtaining first vehicle information by at least one sensor, wherein the first vehicle information provides position information associated with the first vehicle; and
transmitting the first vehicle information to the cloud device.

5. The method for vehicle-to-everything communication as claimed in claim 4, wherein the first vehicle information further comprises: a time, a speed and a driving direction of the first vehicle.

6. A mobile device for vehicle-to-everything (V2X) communication, comprising:
one or more processors; and
one or more computer storage media for storing one or more computer-readable instructions, wherein the processor is configured to drive the computer storage media to execute the following tasks:
receiving an event signal corresponding to an event;
determining whether to perform an action according to the event signal;
wherein the action belongs to one of the following:
generating a warning signal to warn a user of the first vehicle that the event has occurred; and
transmitting a notification signal to a cloud device to notify neighboring second vehicles associated with the first vehicle of the event through the cloud device.

7. The mobile device for vehicle-to-everything communication as claimed in claim 6, wherein the event signal corresponding to the event is transmitted by the first vehicle or the cloud device.

8. The mobile device for vehicle-to-everything communication as claimed in claim 6, wherein the processor further executes the following tasks:
receiving road information and second vehicle information transmitted by the cloud device, wherein the second vehicle information provides position distribution information of the neighboring second vehicles associated with the first vehicle.

9. The mobile device for vehicle-to-everything communication as claimed in claim 6, wherein the processor further executes the following tasks:
obtaining first vehicle information by at least one sensor, wherein the first vehicle information provides position information associated with the first vehicle; and
transmitting the first vehicle information to the cloud device.

10. The mobile device for vehicle-to-everything communication as claimed in claim 9, wherein the first vehicle information further comprises: a time, a speed and a driving direction of the first vehicle.

11. A system for vehicle-to-everything (V2X) communication, comprising:
a cloud device, receiving an event signal corresponding to an event; and
a mobile device, located in a first vehicle in an area;
wherein the cloud device broadcasts the event signal to all vehicles in the area, and the area has a range centered on the event.

12. The system for vehicle-to-everything communication as claimed in claim 11, wherein the event signal corresponding to the event is transmitted by the mobile device.

13. The system for vehicle-to-everything communication as claimed in claim 11, wherein the mobile device receives road information and second vehicle information transmitted by the cloud device, and the second vehicle information provides position distribution information of the neighboring second vehicles associated with the first vehicle.

14. The system for vehicle-to-everything communication as claimed in claim 11, wherein the cloud device further receives first vehicle information transmitted from the associated with the first vehicle, and the cloud device broadcasts the first vehicle information to a plurality of second vehicles in a first area centered on the first vehicle.

15. The system for vehicle-to-everything communication as claimed in claim 14, wherein the first vehicle information further comprises: a time, a speed and a driving direction of the first vehicle.
